(19) United States
(12) Patent Application Publication
(10) Pub. No.: US 2006/0184716 A1
(43) Pub. Date: Aug. 17, 2006

(54) NON-VOLATILE MEMORY DEVICE AND CONTROL METHOD THEREOF

(76) Inventor: Chun-Yu Hsieh, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/908,747

(22) Filed: May 25, 2005

(30) Foreign Application Priority Data
Feb. 14, 2005 (TW) 94104166

(51) Int. Cl. G06F 12/00

(52) U.S. Cl. 711/103

(57) ABSTRACT

The present invention provides a non-volatile memory device and a control method thereof. The memory device comprises a memory controller and a multi-die memory. Since a first and a second non-volatile memory dies in the multi-die memory are enabled at different times by a first and a second chip enable signals provided by the memory controller, the data in the multi-die memory can be accessed continuously to increase the data access rate.

### CROSS-REFERENCE TO RELATED APPLICATION

This application claims the priority benefit of Taiwan application serial no. 941 041 66, filed on Feb. 14, 2005. All disclosure of the Taiwan application is incorporated herein by reference.

### BACKGROUND OF THE INVENTION

1. Field of the Invention

The present invention relates to a non-volatile memory device, and more particularly, to a memory device having a multi-die non-volatile memory that is enabled at different times by different enable signals to increase the data access rate of the memory device and a control method thereof.

2. Description of the Related Art

In order to increase the capacity for data access, two flash memory dies are stacked and packaged together as a flash memory in a typical non-volatile memory such as flash memory, and such flash memory is called a stacked two-die flash memory. The stacked two-die flash memory uses two dies in the flash memory to be accessed interlacedly, thus it can provide higher capacity for data access than the conventional flash memory packaged with only one flash memory die.

FIGS. 1A and 1B schematically show a block diagram and a timing diagram of a conventional stacked two-die flash memory, respectively. Referring to FIG. 1A, the stacked two-die flash memory 110 comprises a first flash memory die 130 and a second flash memory die 150. Whether the data on the first flash memory die 130 and the second flash memory die 150 are accessible or not depends on the fact whether the chip enable signals for the flash memory dies are enabled or not, thus both of the first and second flash memory dies 130 and 150 can be enabled at the same time.

Referring to both FIGS. 1A and 1B, for example, if M bytes data in the stacked two-die flash memory 110 is to be accessed during a unit time Δt, since both of the first and second flash memory dies 130 and 150 are enabled at the same time, during the first half of Δt (i.e. the first Δt/2) where it is enabled, the first flash memory die 130 and the second flash memory die 150 are responsible to be accessed of M/2 bytes data, respectively. During the second half of Δt (i.e. the second Δt/2) where it is disabled, both of the first and second flash memory dies 130 and 150 are idle. Compared with the flash memory packaged with only one die, more data can be accessed on the stacked two-die flash memory 110 during the same period of time.

However, regarding to the data accessed on the stacked two-die flash memory 110, there is no data access in half of the duration (i.e. during the second Δt/2).

### SUMMARY OF THE INVENTION

Therefore, it is an object of the present invention to provide a non-volatile memory device, wherein multiple dies in the non-volatile memory are enabled at different times, thus the desired data can be continuously accessed on the non-volatile memory to increase the data access rate.

It is another object of the present invention to provide a control method of the non-volatile memory, wherein the chip enable signals are provided to the non-volatile memory having a multi-die memory at different times, such that the desired data can be continuously accessed on the non-volatile memory to increase the data access rate.

The present invention provides a non-volatile memory comprising a memory controller and a multi-die memory. The memory controller at least generates a first chip enable signal and a second chip enable signal, and the first and second chip enable signals are enabled at different times. The multi-die memory at least comprises a first non-volatile memory die and a second non-volatile memory die, and whether the data in the first and second non-volatile memory dies are accessible or not depends on the fact whether the first and second chip enable signals are enabled or not.

The present invention provides a control method of a non-volatile memory suitable for a multi-die memory. Wherein, the multi-die memory at least comprises a first non-volatile memory die and a second non-volatile memory die. The control method of the non-volatile memory comprises the following steps: at least providing a first chip enable signal and a second chip enable signal, wherein the first and second chip enable signals are enabled at different times; whether the data in the first and second non-volatile memory dies are accessible or not depends on the fact whether the first and second chip enable signals are enabled or not.

The non-volatile memory device and the control method thereof described in the preferred embodiment according to the present invention further comprises the following steps. When the first non-volatile memory die is enabled (e.g. when the received first chip enable signal is in high potential), a first record of data is accessed on the first non-volatile memory die of the multi-die memory. Then, when the second non-volatile memory die is enabled (e.g. when the received second chip enable signal is in high potential), another record of data is accessed on the second non-volatile memory die of the multi-die memory.

In the non-volatile memory device and the control method thereof described in the preferred embodiment according to the present invention, wherein the non-volatile memory device may be a flash memory device and the multi-die memory may be a stacked two-die memory. Therefore, both of the first and second non-volatile memory dies may be flash memory dies. Furthermore, the first and second non-volatile memory dies may be the memory dies designed with an NAND gate configuration.

The first and second non-volatile memory dies in the multi-die memory are enabled at different times by the first and second chip enable signals, such that the desired data can be interlacedly accessed on the non-volatile memory enabling the first and second non-volatile memory dies. Therefore, the data are continuously accessed and the data access rates are improved.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIGS. 1A and 1B schematically show a block diagram and a timing diagram of a conventional stacked two-die flash memory, respectively.

FIGS. 2A and 2B schematically show a block diagram and a timing diagram of a flash memory device according to a preferred embodiment of the present invention, respectively.

FIG. 3 schematically shows a case where the first and second chip enable signals are non-overlapped with each other during the enable duration.

FIG. 4 schematically shows a flow chart illustrating a control method of a non-volatile memory according to a preferred embodiment of the present invention.

### DESCRIPTION OF THE PREFERRED EMBODIMENTS

In order to have a better understanding of the embodiments described in the present invention, for example, a flash memory is used as a non-volatile memory device and a two-die memory is used as a multi-die memory hereinafter. Accordingly, the non-volatile memory device is referred to as a flash memory device, and the first and second non-volatile memory dies are referred to as the first and second flash memory dies, respectively. Other types of the non-volatile memory device may be easily inferred by one of the ordinary skill in the art.

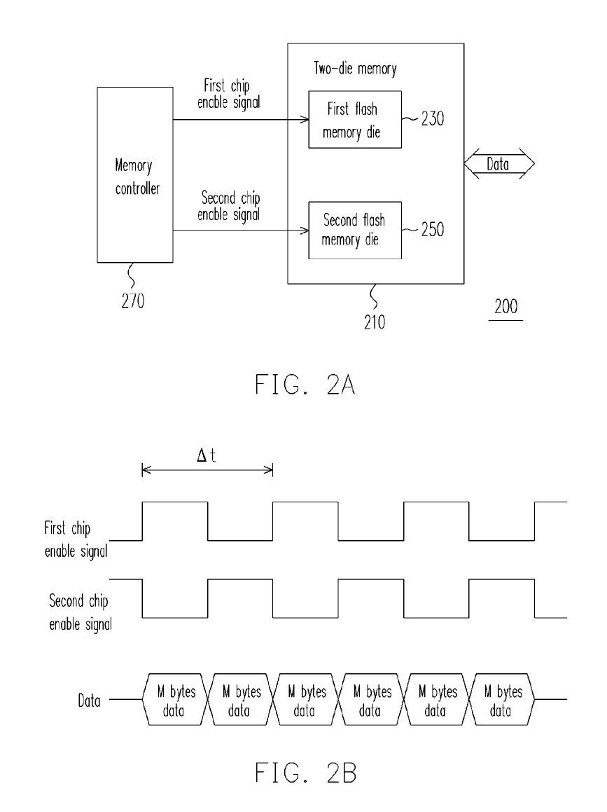

FIGS. 2A and 2B schematically show a block diagram and a timing diagram of a flash memory device according to a preferred embodiment of the present invention, respectively. Referring to FIG. 2A, the flash memory device 200 comprises a two-die memory 210 and a memory controller 270. Wherein, the two-die memory 210 comprises a first flash memory die 230 and a second flash memory die 250. The memory controller 270 provides a first chip enable signal and a second chip enable signal that are enabled at different times. Whether the data in the first flash memory die 230 and the second flash memory die 250 are accessible or not depends on the fact whether the first and second chip enable signals are enabled or not.

Referring to both FIGS. 2A and 2B, it is assumed that the first and second chip enable signals are enabled when they are in high potential. The first and second chip enable signals also may be defined as enabled when they are in low potential by one of the ordinary skill in the art based on the spirit of the invention, and modifications to the described embodiment may be made without departing from the spirit of the invention. The data access operation is performed only when the chip enable signal received by the first flash memory die 230 is in high potential, and it is idle when the received chip enable signal is in low potential. In addition, the operation of the second flash memory die 250 is the same as the operation of the first flash memory die 230 mentioned above. Therefore, the so-called “being enabled at different times” of the first and second chip enable signals indicates when the first flash memory die 230 is enabled by the first chip enable signal (meanwhile it is in high potential), the second flash memory die 250 should be disabled by the second chip enable signal (meanwhile it is in low potential). In other words, when the first flash memory die 230 is being accessed, the second flash memory 250 is idle. On the other hand, when the first flash memory die 230 is idle, the second flash memory die 250 is accessed at the moment.

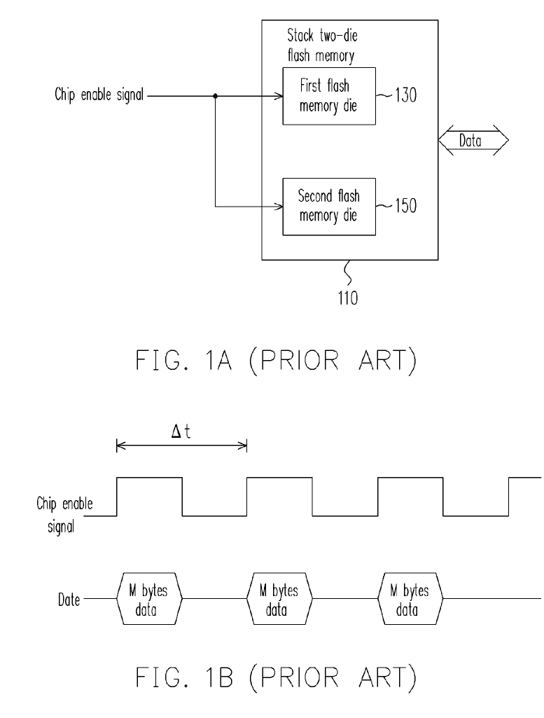

In accordance with the concept of the present invention, when it is compared with the timing diagram of the conventional stacked two-die flash memory 110 in FIG. 1B, under the same condition of a unit time Δt, within the two-die memory 210, M bytes data is accessed on the first flash memory die 230 when it is enabled during the first half of Δt (i.e. the first Δt/2), and then it is idle during the second half of Δt (i.e. the second Δt/2) when it is disabled. In addition, M bytes data is accessed on the second flash memory die 250 when it is enabled during the second half of Δt (i.e. the second Δt/2), and then it is idle during the first half of Δt (i.e. the first Δt/2) when it is disabled. Accordingly, totally 2 M bytes of data can be accessed on the two-die memory 210 during the unit time Δt. Compared with the conventional stacked two-die flash memory 110 in FIG. 1A, the two-die memory 210 of the present embodiment can access two times of data amount during the same period of time.

In addition, in order to provide more storage capacity with the same size of die, the two-die memory 210 may be a stacked two-die memory. Furthermore, in order to provide a higher level of integration of the memory dies, the design of NAND memory cell may be utilized.

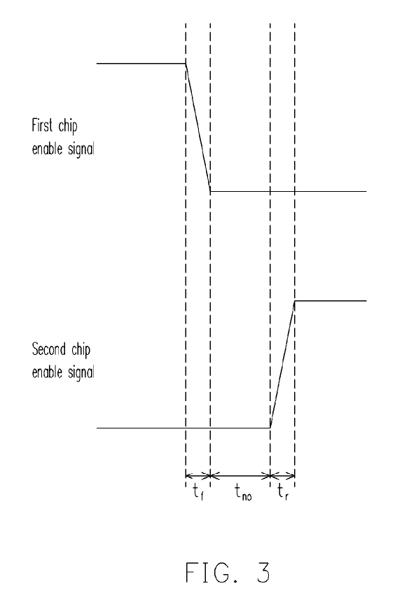

In a preferred embodiment of the present invention, the two flash memory dies are enabled with a level-sensitive approach. To avoid conflict in data access, when the first chip enable signal is enabling the first flash memory die 230, the second chip enable signal must disable the second flash memory die 250 at the same time. In other words, the enable durations of the first and second chip enable signals must be non-overlapped with each other. FIG. 3 schematically shows a case where the first and second chip enable signals are non-overlapped with each other during the enable duration. Referring to FIG. 3, the enable duration (i.e. the high potential period) of the first chip enable signal must be non-overlapped with the enable duration (i.e. the high potential period) of the second chip enable signal, that is the non-overlap time tₙₒ must be greater than or equal to 0.

If the non-overlap time tₙₒ is equal to 0, that is, after the first flash memory die 230 was enabled to access a first record of data and then has just been disabled, the second flash memory die 250 will be enabled immediately from its original disable state to access another record of data. Therefore, compared with the conventional stacked two-die flash memory 110, the two-die memory 210 of the present embodiment can access two times of data amount of the stacked two-die flash memory 110 during the same period of time. However, the transition of the physical signal (e.g. from high potential to low potential) requires a certain period of time. The time required for the first chip enable signal to change from high potential to low potential is referred to as a falling time t_{f}, and the time required for the second chip enable signal to change from low potential to high potential is referred to as a rising time tr. In fact, the two-die memory 210 can provide near two times of the data access rate of the conventional stacked two-die flash memory 110.

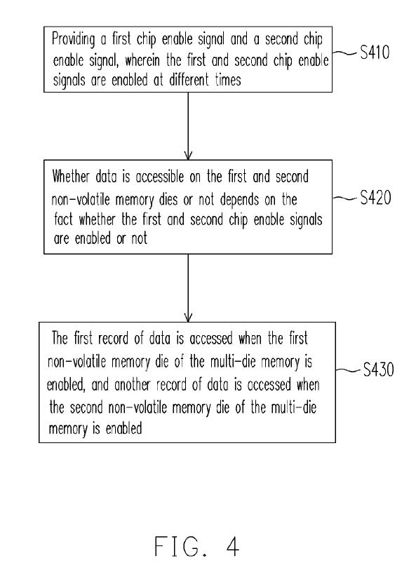

FIG. 4 schematically shows a flow chart illustrating a control method of a non-volatile memory according to a preferred embodiment of the present invention. Wherein, the control method is suitable for a multi-die memory. The multi-die memory at least comprises a first non-volatile memory die and a second non-volatile memory die. The multi-die memory may be a two-die memory, and the first and second non-volatile memory dies may be the flash memory dies. Alternatively, in order to provide higher storage capacity with the same size of die, the multi-die memory may be a stacked multi-die memory and incorporates with an NAND cell design.

Referring to FIG. 4, first in step S410, a first chip enable signal and a second chip enable signal are provided. Wherein, the first and second chip enable signals are enabled at different times. For example, the first and second chip enable signals are enabled when they are in high potential. When the first chip enable signal is in high potential (e.g. it is enabled), the second chip enable signal is in low potential (e.g. it is disabled). Modifications of the present embodiment, such as the first and second chip enable signals are enabled when they are in low potential, are also considered as within the scope of the present invention.

Then, in step S420, whether data is accessible on the first and second non-volatile memory dies or not depends on the fact whether the first and second chip enable signals are enabled or not. Finally, in step S430, a first record of data is accessed when the first non-volatile memory die of the multi-die memory is enabled, and another record of data is accessed when the second non-volatile memory die of the multi-die memory is enabled. Thus, the desired data can be continuously accessed on the first and second non-volatile memory dies by enabling both memory dies at different times to increase the data access rate.

In summary, the present invention provides a non-volatile memory device and a control method thereof. The first and second non-volatile memory dies in the multi-die memory are controlled by the first and second chip enable signals which are enabled at different times respectively such that the desired data in the multi-die memory can be continuously accessed to increase the data access rate.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A non-volatile memory device, comprising:
a memory controller, for at least generating a first chip enable signal and a second chip enable signal, wherein the first and the second chip enable signals are enabled at different times; and
a multi-die memory, at least comprising a first non-volatile memory die and a second non-volatile memory die, wherein whether the first and the second non-volatile memory dies are accessible or not depends on the fact whether the first and the second chip enable signals are enabled or not.

2. The non-volatile memory device of claim 1, wherein when the first non-volatile memory die is enabled, a first record of data is accessed on the first non-volatile memory die in the multi-die memory, and when the second non-volatile memory die is enabled, another record of data is accessed on the second non-volatile memory die in the multi-die memory.

3. The non-volatile memory device of claim 1, wherein the first non-volatile memory die is enabled only when the received first chip enable signal is in high potential, and the second non-volatile memory die is enabled only when the received second chip enable signal is in high potential.

4. The non-volatile memory device of claim 1, wherein the non-volatile memory device is a flash memory device, and both of the first and the second non-volatile memory dies are flash memory dies.

5. The non-volatile memory device of claim 1, wherein the multi-die memory is a stacked two-die memory.

6. The non-volatile memory device of claim 1, wherein both of the first and the second non-volatile memory dies are NAND non-volatile memory dies.

7. A control method of a non-volatile memory suitable for a multi-die memory, wherein the multi-die memory at least comprises a first non-volatile memory die and a second non-volatile memory die, and the control method of the non-volatile memory comprises:
at least providing a first chip enable signal and a second chip enable signal, wherein the first and the second chip enable signals are enabled at different times;
wherein whether the first and the second non-volatile memory dies are accessible or not depends on the fact whether the first and the second chip enable signals are enabled or not.

8. The control method of the non-volatile memory of claim 7, further comprising when the first non-volatile memory die is enabled, a first record of data is accessed on the first non-volatile memory die in the multi-die memory, and when the second non-volatile memory die is enabled, another record of data is accessed on the second non-volatile memory die in the multi-die memory.

9. The control method of the non-volatile memory of claim 7, wherein the first non-volatile memory die is enabled only when the received first chip enable signal is in high potential, and the second non-volatile memory die is enabled only when the received second chip enable signal is in high potential.

10. The control method of the non-volatile memory of claim 7, wherein both of the first and the second non-volatile memory dies are flash memory dies.

11. The control method of the non-volatile memory of claim 7, wherein the multi-die memory is a stacked two-die memory.

12. The control method of the non-volatile memory of claim 7, wherein both of the first and the second non-volatile memory dies are NAND non-volatile memory dies.
